(19) United States
(12) Patent Application Publication
(10) Pub. No.: US 2003/0160762 A1
(43) Pub. Date: Aug. 28, 2003

(54) Rechargeable wireless mouse

(76) Inventor: Ho-Lung Lu, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/079,549

(22) Filed: Feb. 22, 2002

(51) Int. Cl. G09G 5/08

(52) U.S. Cl. 345/163

(57) ABSTRACT

A rechargeable wireless mouse is constructed to include a mouse body, the mouse body having a rechargeable battery, a plug chamber on the outside, and power input contact means disposed in the plug chamber and electrically connected to the rechargeable battery; and an electric plug detachably mounted in the plug chamber of the mouse body and adapted to receive external power supply to charge the rechargeable battery, the electric plug having power output contact means adapted for contacting the power input contact means of the mouse body and metal blades adapted for connecting to city AC power.

### BACKGROUND OF THE INVENTION

1. Field of the Invention

The present invention relates to a wireless mouse and, more particularly, to a rechargeable wireless mouse, which is equipped with a rechargeable battery and has a power input plug adapted to receive AC power supply from an electric outlet for charging the rechargeable battery.

2. Description of the Related Art

Computer input devices are numerous. A mouse is one of the most popularly used computer input devices. By means of moving mouse cursor and clicking mouse button, a mouse eliminates complicated keyboard input operation. Conventional mice commonly have a transmission cable for connection to the computer. However, the transmission cable limits the moving range of the mouse relative to the computer and, tends to be tangled with other objects on the table. In order to eliminate these drawbacks, wireless mice are developed. FIG. 1 illustrates the use of a wireless mouse system with a computer. As illustrated, the wireless mouse system comprises a transmitter unit 1a, namely, the wireless mouse, and a receiver unit 2a connected to the computer 4a through a transmission cable 3a. The transmitter unit 1a is controlled to transmit signal to the receiver unit 2a by radio wave or infrared ray. The receiver unit 2a converts the signal from the transmitter unit 1a into a computer readable signal, and then passes the signal to the computer 4a through the transmission cable 3a. The transmitter unit 1a has a set of battery cells 5a, which provides the transmitter unit 1a with the necessary working power. This structure of wireless mouse is functional. However, the wireless mouse cannot obtain the necessary working power from the computer 4a. When the power of the battery cells 5a is low, the battery cells 5a should be replaced. Further, used battery cells must be properly disposed of to prevent environmental pollution.

### SUMMARY OF THE INVENTION

The present invention has been accomplished under the circumstances in view. One object of the present invention is to provide a wireless mouse, which is equipped with a rechargeable battery that provides the necessary working power. Another object of the present invention is to provide a wireless mouse, which has a power input plug adapted to receive city AC power for charging the rechargeable battery stored therein. To achieve these and other objects of the present invention, the rechargeable wireless mouse is comprised of a mouse body, and an electric plug. The mouse body comprises a rechargeable battery, a plug chamber on the outside, and power input contact means disposed in the plug chamber and electrically connected to the rechargeable battery. The electric plug is detachably mounted in the plug chamber of the mouse body and adapted to receive external power supply to charge the rechargeable battery, comprising power output contact means adapted for contacting the power input contact means of the mouse body and metal blades adapted for connecting to city AC power.

### BRIEF DESCRIPTION OF THE DRAWINGS

FIG. 1 illustrates the arrangement of a wireless mouse system with a computer according to the prior art.

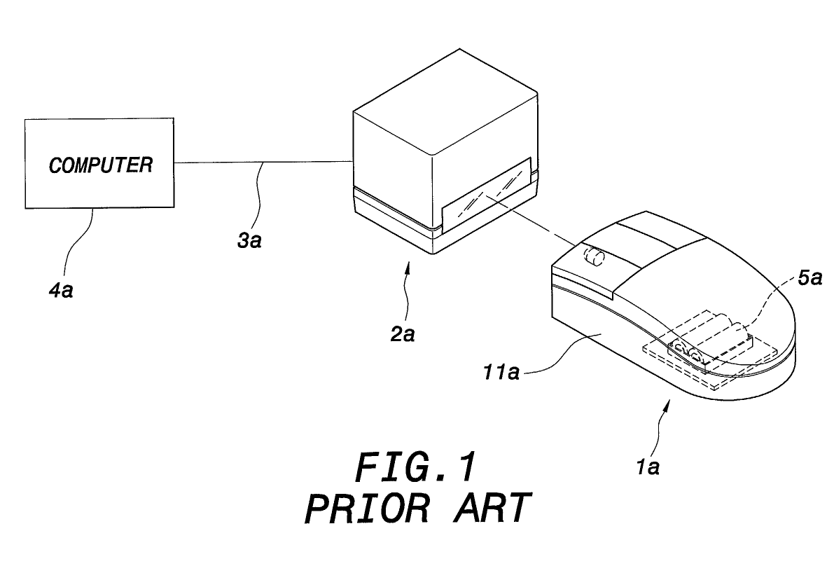

FIG. 2 is a schematic view of a rechargeable wireless mouse according to the present invention.

FIG. 3 is a circuit block diagram of the present invention.

FIG. 4 is a circuit block diagram of the power adapter according to the present invention.

FIG. 5 illustrates the relationship between the rechargeable wireless mouse and an electric outlet according to the present invention.

### DETAILED DESCRIPTION OF THE PREFERRED EMBODIMENT

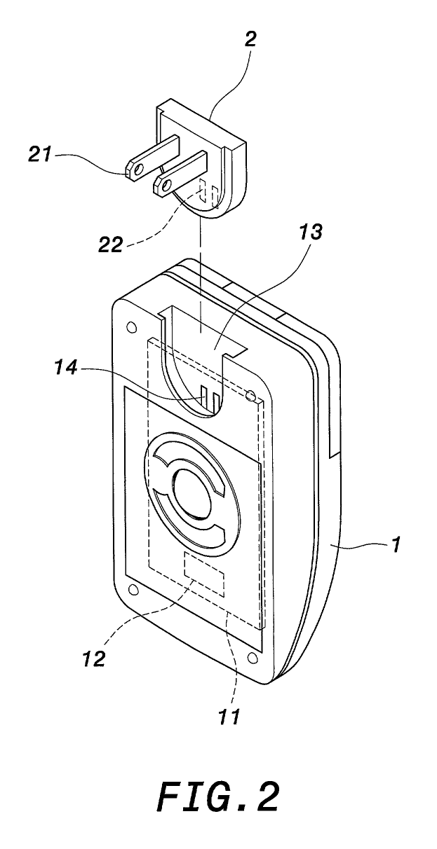

Referring to FIG. 2, a rechargeable wireless mouse is shown comprising a mouse body 1 and an electric plug 2. The mouse body 1 comprises an electric circular board 11 mounted on the inside, a rechargeable battery 12 electrically coupled to the circuit board 11, a plug chamber 13 in one end of the bottom side and adapted to receive the electric plug 2, and metal contacts 14 disposed in the plug chamber 13 and electrically connected to the circuit board 11. The electric plug 2 comprises two metal blades 21 for connection to an electric outlet to receive city AC power, and two metal contacts 22 electrically coupled to the metal blades 21 and adapted for contacting the metal contacts 14 of the mouse body 1. After installation of the electric plug 2 in the plug chamber 13 and connection of the electric plug 2 to an electric outlet, city AC power is transmitted through the electric plug 2 to the circuit board 11 to charge the rechargeable battery 12.

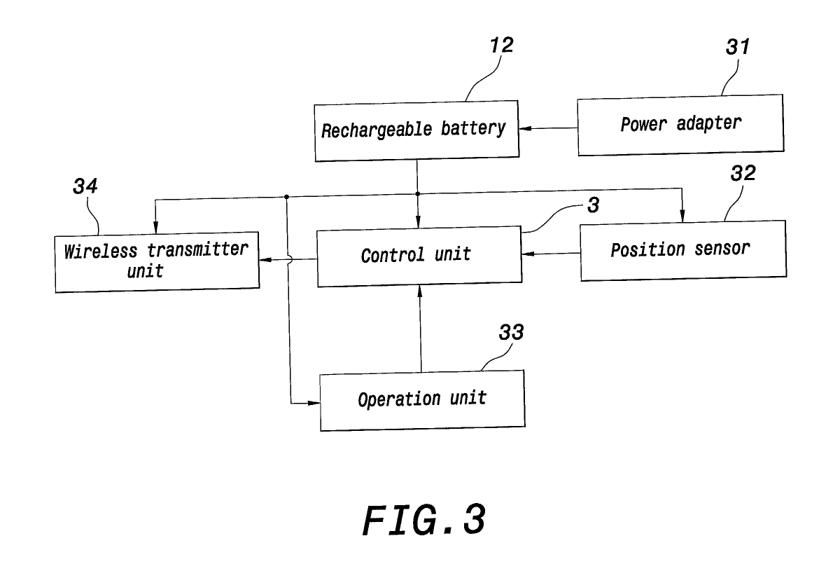

FIG. 3 is a circuit block diagram of the present invention, which comprises a power adapter 31 adapted to convert external AC power received from the electric plug 21 (see also FIG. 2) into DC power, a rechargeable battery 12 electrically coupled to the output end of the power adapter 31 to receive DC power so as to provide the necessary working voltage to the mouse body 1, a control unit 3 adapted to control all actions of the mouse body 1, a position sensor 32 electrically coupled to the control unit 3 and adapted to receive message of movement of the mouse body 1, an operation unit 33 electrically coupled to the control unit 3 and adapted to receive actuation message of the buttons or rotation message of the wheel of the mouse body 1, and a wireless transmitter unit 34 electrically coupled to the control unit 3 and adapted to transmit signal from the control unit 3 to the outside by radio or infrared.

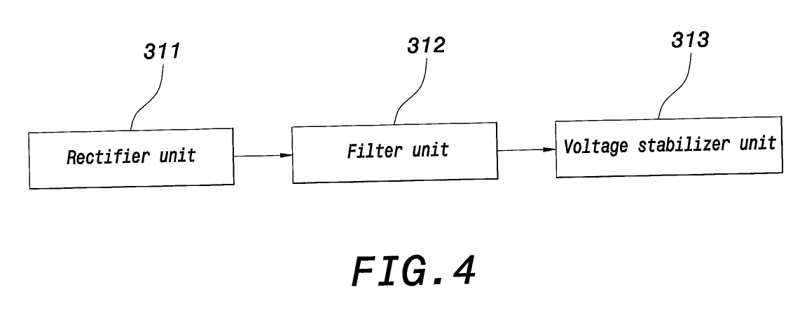

Referring to FIG. 4, the aforesaid power adapter 31 can be installed in the electric plug 2 or the mouse body 1, comprising a rectifier unit 311 adapted to remove negative half cycle voltage from city AC power received through the metal blades 21 of the electric plug 2, a filter unit 312 adapted to filtrate received input power from the rectifier unit 311 into a ripple voltage, and a voltage stabilizer unit 313 adapted to stabilize the ripple voltage into stable DC power for charging the rechargeable battery 12.

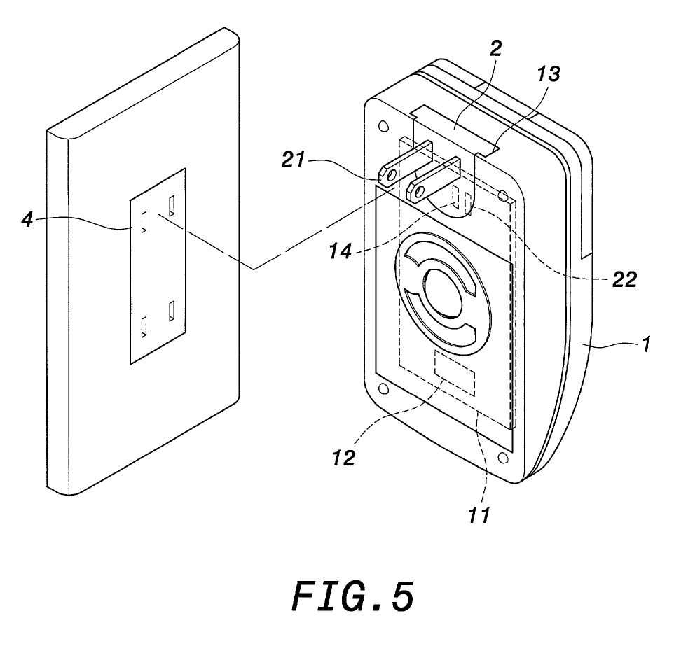

Referring to FIG. 5, when the power of the rechargeable battery 12 is low, the user can mount the electric plug 2 in the plug chamber 13 of the mouse body 1 and then plug the metal blades 21 of the electric plug 2 into an electric outlet 4, enabling the rechargeable battery 12 to be charged to the saturated status. Because city AC power supply can easily be obtained, the rechargeable battery 12 of the rechargeable wireless mouse can quickly be charged when power low.

As indicated above, the present invention provides a rechargeable wireless mouse, which has a power input plug to receive city AC power supply and, which has a rechargeable battery that provides the necessary working power supply.

A prototype of rechargeable wireless mouse has been constructed with the features in FIGS. 2˜5. The rechargeable wireless mouse functions smoothly to provide all of the features discussed above.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A rechargeable wireless mouse comprising a mouse body, a rechargeable battery installed in said mouse body, and power input contact means disposed in said mouse body and electrically connected to said rechargeable battery.

2. The rechargeable wireless mouse as claimed in claim 1, wherein said power input contact means is provided in a plug chamber on the outside of said mouse body.

3. The rechargeable wireless mouse as claimed in claim 2, further comprising an electric plug insertable in said plug chamber of said mouse body, said electric plug having power output contact means for connection to said power input contact means in said mouse body.

4. The rechargeable wireless mouse as claimed in claim 3, wherein said electric plug comprises a plurality of metal blades electrically coupled to said power output contact means and adapted for connecting to an external power source.

5. The rechargeable wireless mouse as claimed in claim 4, wherein said external power source is city AC power.

6. A rechargeable wireless mouse comprising:
a mouse body, said mouse body comprising a rechargeable battery, a plug chamber, and power input contact means disposed in said plug chamber and electrically connected to said rechargeable battery; and
an electric plug adapted for mounting in said plug chamber of said mouse body, said electric plug comprising power output contact means adapted for contacting said power input contact means of said mouse body, and a plurality of metal blades adapted for connecting to an external power source.

7. The rechargeable wireless mouse as claimed in claim 6, wherein said power output contact means is electrically coupled to said metal blades.

8. The rechargeable wireless mouse as claimed in claim 6, wherein said external power source is city AC power.
